(19) United States
(12) Patent Application Publication
(10) Pub. No.: US 2008/0193587 A1
(43) Pub. Date: Aug. 14, 2008

(54) COMPOSITION AND METHOD OF FEEDING A YOUNG LIVESTOCK ANIMAL

(76) Inventors: Drew A. Vermeire, St. Louis, MO (US); Joseph G. Tegethoff, Platte, SD (US)

Correspondence Address: Patrick W. Rasche;Armstrong Teasdale LLP, Suite 2600, One Metropolitan Square, St. Louis, MO, 63102, US

(21) Appl. No.: 11/673,318

(22) Filed: Feb. 9, 2007

(51) Int. Cl. A23K 1/18; A23C 9/158; A23C 21/00; A23C 9/16; A23C 9/00

(52) U.S. Cl. 426/2; 426/580; 426/72; 426/583; 426/588

(57) ABSTRACT

A method for producing a composition formulated for young livestock. The method includes mixing distillers solubles with at least one of a milk replacer powder, whole milk, and waste milk.

### BACKGROUND OF THE INVENTION

This invention relates generally to young animal feed and, more specifically, to compositions that may be used with milk replacers, whole milk, or waste milk.

Feeding young livestock, such as calves, horses, sheep, goats, pigs and other livestock, presents unique challenges for farmers and animal feed companies. For example, the major developments in a calf's digestive tract occur in the first six months of the calf's life. This development may be influenced by the type of feed given to the calf. Furthermore, calves are very susceptible to infections, such as scours, early on in their lives.

A major component of a young animal's diet has traditionally consisted of fresh, whole milk and, more recently, milk replacers. Milk replacers primarily include milk-derived ingredients, such as dried skim milk, whey, and/or whey protein concentrate. However, the cost of milk-derived ingredients has led to the search for other ingredients to supply protein and energy in the diet of young animals.

One alternative, distillers solubles, is a co-product or by-product of the production of alcohol through the milling of cereals such as barley, maize (corn), rye, sorghum, or wheat. Although some U.S. Patents and other publications consider feeding adult cattle with various distillery products and byproducts, none of them consider using milk replacer compositions for feeding young livestock (e.g., calves) wherein the milk replacer includes distillers solubles.

Distillers solubles are not used to feed neonatal animals because it is commonly known by persons skilled in the art and science of animal nutrition that neonatal animals cannot effectively digest or utilize complex carbohydrates, various proteins, or fats and oils contained in the grains. For example, the Cooperative Extension Service of The University of Georgia, College of Agricultural and Environmental Sciences, includes in its publication “Raising Dairy Herd Replacements” a table entitled “Quality of Proteins & Fats in Milk Replacers”. The table lists distillers solubles as “inferior” (Table 3, page 4). This table has been widely cited and reproduced in other publications.

In fact, feeding calves with milk replacer compositions made from distillers solubles is so discouraged that a search of the Agricola database of published agricultural research from the National Agricultural Library, USDA, Beltsville, Md. fails to show any research in which distillers solubles was actually fed to calves in a controlled research study.

Nevertheless, there is a continuing need for alternative ingredients to be used in feed and milk replacers for young animals.

### BRIEF DESCRIPTION OF THE INVENTION

In one aspect, a method for producing a composition formulated for young livestock is provided. The method includes mixing distillers solubles with at least one of a milk replacer powder, whole milk, and waste milk.

In another aspect, a method for feeding a young livestock animal is provided. The method includes feeding the young animal a composition including distillers solubles and at least one of a milk replacer powder, whole milk, and waste milk.

In another aspect, a composition for feeding a young livestock animal is provided. The composition includes distillers solubles and at least one of a milk replacer powder, whole milk, and waste milk.

### DETAILED DESCRIPTION OF THE INVENTION

Although embodiments of the present invention generally relate to young livestock feed, including feed for neonatal livestock, the present invention can also be used in feeding other mammals, such as humans, pets or other companion animals, and wild animals including those kept in captivity.

The term “livestock,” as used herein, includes any animal that is used for labor, food, clothing, entertainment, or research, and reared in an agricultural setting. Livestock includes pigs, cattle, goats, deer, sheep, horses, and buffalo.

The term “ruminants,” as used herein, includes any hooved animal reared in an agricultural setting that digests its feed with the ruminating process, including neonatal animals of ruminant species which have not fully developed the ruminant system (“preruminants”).

The term “young,” as used herein, includes the development period of an immature animal, including the neonatal period.

The term “neonatal,” as used herein, includes the first six to twelve weeks of an animal's life.

It is known by persons skilled in the art of animal nutrition that young livestock, and especially neonatal livestock, cannot effectively digest or utilize complex carbohydrates, various proteins, or fats and oils contained in grains. Consequently, many milk replacer producers and universities with agricultural services actively advise to not use distillers solubles in milk replacers. The inventors have surprisingly discovered that modern distiller by-products (i.e., distillers solubles) may be used as an ingredient in milk replacer compositions. Without being held to one particular theory, the inventors believe that modern processes used in making distillers solubles result in safer and/or more nutritious distillers solubles. Modern distillers solubles may have a higher nutrient quality because: 1) the yeast strains used in ethanol production may produce different fatty acid compositions than the oil originally contained in the corn; 2) enzyme treatments used to reduce the thickness or viscosity of distillers solubles may improve digestibility of solubles for neonatal animals; 3) quality control involved in producing ethanol is far superior today than in the past; 4) methods of dehydrating and drying distillers grains are more carefully controlled than in previous years.

Distillers solubles derive from various cereals, such as barley, corn, rye, sorghum, or wheat. In one embodiment of the invention, the distillers solubles include at least one of corn, wheat, and barley.

Corn and other grains are converted into ethanol by three commercial processes: wet milling, dry grinding, and dry milling. Each process can produce various types of distillers solubles, for example, stillage, steepwater, condensed distillers solubles, and dried distillers solubles. Stillage is a by-product in the fermentation process of grains. By screening and pressing or centrifuging the stillage, wet distillers grains and thin stillage are obtained. Usually, the wet distiller grains are dried to yield dried distiller grains. If these dried grains are combined with thin stillage at drying, the product formed is called dried distillers grains with solubles (DDGS). Optionally, the solubles in the thin stillage can be partially dried to make condensed distillers solubles, commonly called “syrup,” or totally dried to make dried distillers solubles. In one embodiment of the invention, the solubles are obtained from dry grind or modified dry grind processes.

Distillers solubles contain varying levels (on a dry matter basis) of crude protein (approximately 15-35%), crude fat (approximately 5-30%), fiber (up to approximately 5%) and various levels of vitamins, minerals, and amino acids. The amino acid and fatty acid profile of the solubles are generally reflective of the grains used in producing the alcohol.

Compositions of the present invention include adequate levels of fat, protein, vitamins, minerals, and amino acids for young livestock. Those skilled in the art possess knowledge in producing these compositions, such as a milk replacer composition. For example, “Raising Dairy Herd Replacements” by The University of Georgia, College of Agricultural and Environmental Sciences (January 2000) provides guidelines for milk replacer compositions, as shown in Table 1.

TABLE 1
Guidelines for Milk Replacer Compositions

| | Age of Calf (days) | | |
|---|---|---|---|
| Nutrient | 4–14 | 14–21 | >21 |
| Crude | 22.0 | 22.0 | 24.0 |
| Protein % | | | |
| Crude Fat % | 10.0 | 10.0 | 10.0 |
| Crude Fiber % | 0.25 | 0.5 | 1.0 |
| Vitamin A | 10,000 IU/lb | 10,000 IU/lb | 10,000 IU/lb |
| Vitamin D₃ | 1,500 IU/lb | 1,500 IU/lb | 1,500 IU/lb |
| B complex | + | + | + |

Generally, milk replacer compositions are in powder form (approximately 95% dry matter) and added to water or some other liquid to yield a final mixed product that can be fed to a young livestock animal. Generally, the final mixed product or solution may range from 10-35% solids. In one embodiment, the final mixed product or solution is approximately 12.5% solids.

The phrase “milk replacer compositions,” as used herein, not only includes milk replacers produced entirely from separate materials (i.e., “from scratch”), but also includes milk replacers made from combining commercial milk replacers or other generic milk replacers with distillers solubles, in either dry or syrup form.

Distillers solubles are useful in that the solubles possess improved mixing, suspending, and dispersing characteristics when compared to plant protein sources that are also used in milk replacer compositions, such as soy flour, soy isolate, soy concentrate, wheat isolate, wheat gluten, and potato protein. Thus, when distillers solubles are added to milk replacer powders and mixed with water or another liquid, the final mixture shows improved suspension and dispersion characteristics.

Compositions of the present invention include distillers solubles from about 1% to about 95%, by weight on a dry matter basis. In one embodiment, the composition includes distillers solubles from about 1% to about 75%, by weight on a dry matter basis. In another embodiment, the composition includes distillers solubles from about 1% to about 50%, by weight on a dry matter basis. More specifically, the composition includes distillers solubles from about 1% to about 20%, by weight on a dry matter basis.

The crude protein percentage (%) of the final composition is from about 16% to about 30%, by weight on a dry matter basis. The protein can come from a variety of sources such as whey powder, delactosed whey, whey protein concentrate, egg proteins, soy flour, soy isolate, soy concentrate, wheat isolate, wheat gluten (including hydrolyzed wheat gluten), potato protein, and animal plasma proteins.

Fat levels in embodiments of the present invention generally range from about 10% to about 30%. In one embodiment, the crude fat % is from about 15% to about 20%, by weight on a dry matter basis. In another embodiment, the crude fat % is from about 10% to about 20%, by weight on a dry matter basis. Furthermore, those skilled in the art know that higher fat milk replacer compositions are often selected for cold climates while lower fat formulas are more often used in warmer climates and in formulations designed for intensive milk replacer feeding programs. The fat may come from a variety of sources including animal, such as lard and white grease, and vegetable oils, such as soy, palm, and coconut oil.

Carbohydrates that may be used with milk replacer compositions include lactose, glucose and galactose.

In some embodiments, the composition further includes medication for the young animal, such as decoquinate, lasalocid, oxytetracycline, and/or neomycin.

Vitamins, minerals, and/or amino acids may be added to balance the nutrient composition of the distillers solubles and other ingredients. For example, vitamins, minerals, and/or amino acids may be added so as to not induce diarrhea, poor growth, or weight loss associated with allergic reaction to other plant-derived ingredients. In one embodiment, at least one of Vitamins A, D, E, K, C, B12, thiamin, riboflavin, niacin, folic add, pantothenic add, biotin, pyridoxine are added, or at least one of calcium, phosphorus, potassium, sodium, chloride, sulfur, zinc, manganese, copper, iron, selenium, cobalt, iodine are added, or at least one of lysine, threonine, methionine, and tryptophan are added to balance the nutrient composition of distillers solubles and other ingredients.

Distillers solubles may also be added to whole milk or waste milk. Waste milk is milk that cannot be used for human consumption because, for example, the milk may contain colostrum or medications.

The examples described below are merely illustrative of the methods and compositions described herein. It is not intended to limit the scope of the invention which is only described and limited by the claims.

A study was conducted to compare performance of calves fed milk replacer compositions with and without distillers solubles. Calves were randomly assigned to one of four treatments: 1) Negative control. Calves were fed 8 ounces of a milk replacer powder (20% protein/20% fat) mixed with 2 quarts of total solution twice per day. 2) Calves were fed 12 ounces of a mixture on a dry matter basis of 10% distillers solubles/90% milk replacer (the total mixture having 26.25% protein/14% fat) mixed with 2 quarts of total solution twice per day. 3) Calves were fed 12 ounces of a mixture on a dry matter basis of 20% distillers solubles/80% milk replacer (the total mixture having 26.25% protein/14% fat) mixed with 2 quarts of total solution twice per day. 4) Positive control. Calves were fed 12 ounces of a milk replacer (26.25% protein/14% fat) mixed with 2 quarts of total solution twice per day. The milk replacer powder used in all of the above treatments was composed of whey, whey protein concentrate, and blend of tallow, lard, and coconut oil.

The calves were weighed on day 1, day 16, and day 30. From day 1 to 16, the calves were fed their respective treatment milk replacer diets. Beginning on day 16, the calves were offered a commercial calf starter feed on a free-choice basis. The weight gains for each group were compared with a covariate analysis (initial weight) for a completely randomized experiment using Statistix for Windows (version 8.0) because the calves' initial weights were not equal among treatments. During the initial milk-fed phase (days 1-16), calves fed the positive control gained the most weight, followed by 20% distillers solubles, 10% distillers solubles, and the negative control. During the second period (days 16-30), calves fed 10% distillers solubles gained the most weight, followed by the negative control, the positive control and 20% distillers solubles. Overall (days 1-30), calves fed 10% distillers solubles gained the most weight, followed by the positive control, 20% distillers solubles, and negative control.

These results demonstrate a use for distillers solubles as an ingredient in milk replacer compositions or as an ingredient added to whole milk or waste milk. While those persons skilled in the art of animal nutrition would recognize that protein derived from corn is generally deficient in the amino acid lysine, and no supplemental lysine was fed in this trial to compensate for the corn protein, performance of calves fed 10% or 20% distillers solubles was superior to performance of calves fed the 20% protein/20% fat milk replacer, which is the standard milk replacer for calf feeding in the United States. Supplementation of distillers solubles with amino acids would likely result in superior calf performance to that which was demonstrated in this study. Without being held to a hypothesis or theory, the inventor believes that modern practices in producing ethanol result in better distillers solubles for use in milk replacers than the distillers solubles produced in the past.

Samples of distillers solubles were collected from a corn-ethanol plant and submitted for analysis. Table 2 shows an analysis of the distillers solubles.

TABLE 2
Analysis of Distillers Solubles (W/W %)*

| | | | | Fatty Acid Profile | |
|---|---|---|---|---|---|
| Basic Profile | | Amino Acid Profile | | (expressed as % of total fat) | |
| Crude Protein | 27.64 | Taurine | 0.03 | Myristic (14:0) | 0 |
| Crude Fat | 14.81 | Hydroxyproline | 0.61 | Myristoleic (14:1) | 0 |
| Crude Fiber | 0.55 | Aspartic Acid | 1.78 | (C15:0) | 0 |
| Ash | 8.93 | Threonine | 1.11 | Palmetic (16:0) | 13.65 |
| Moisture | 80.84 | Serine | 1.11 | Palmitoleic (16:1) | 0 |
| Starch | 19.25 | Glutamic Acid | 2.46 | (17:0) | 0 |
| Glucose | 4.03 | Proline | 1.49 | (17:1) | 0 |
| Fructose | nd* | Lanthionine | 0 | Stearic (18:0) | 2.57 |
| Sucrose | nd* | Glycine | 1.43 | Elaidic (18:1t9) | 0 |
| | | Alanine | 1.69 | Oleic (18:1t9) | 27.96 |
| | | Cysteine | 0.44 | Vaccenic (18:1n7) | 0 |
| | | Valine | 1.54 | Linoleic (18.2) | 52.85 |
| | | Methionine | 0.48 | Linolenic (ω 18.4) | 1.57 |
| | | Isoleucine | 1.1 | (ω 18.4) | 0 |
| | | Leucine | 2.3 | Arachidic (20:0) | 0.5 |
| | | Tyrosine | 0.78 | (20:1n9) | 0.26 |
| | | Phenylalanine | 1.05 | (20:3 ω3) | 0 |
| | | Hydroxylysine | 0.08 | Arachidonic (20:4n6) | 0 |
| | | Histidine | 0.86 | Arachidonic (20:4 ω3) | 0 |
| | | Ornithine | 0.06 | (20:5 ω3; EPA) | 0 |
| | | Lysine | 1.47 | Docosanoic (22:0) | 0.27 |
| | | Arginine | 1.53 | Erucic (22:1n9) | 0 |
| | | Tryptophan | 0.28 | (22:5 ω3; DPA) | 0 |
| | | Total | 23.68 | (22:5 ω3; DHA) | 0 |
| | | | | Lignoceric (24:0) | 0.37 |
| | | | | Nervonic (24:1n9) | 0 |

*W/W %, weight/weight percent, or gram/100 gram sample (all are equivalent);
nd, not detected.
All data are presented on a dry weight basis.

Notably, over half of the fatty acid content is in the form of linoleic acid which has been shown to be a required fatty acid for calves.

Furthermore, comparisons of distillers solubles from two facilities showed an average protein content from 19.90-20.38%, and an average fat content from 18.68-22.08%.

In another embodiment, a method for producing a composition formulated for young livestock is provided. The method includes mixing distillers solubles with at least one of a milk replacer powder, whole milk, and waste milk.

In another embodiment, a method for feeding a young livestock animal is provided. The method includes feeding the young animal a composition including distillers solubles and at least one of a milk replacer powder, whole milk, and waste milk.

Described herein is a composition that may be utilized in feeding a wide variety of young animals. Compositions that include distillers solubles offer alternative ingredients to those using milk replacers, whole milk, or waste milk. This can reduce the costs in feeding the young animals.

Exemplary embodiments of a composition and a method for feeding a young animal are described above in detail. The composition and the method illustrated are not limited to the specific embodiments described herein, but rather, components of each composition and steps of each method may be utilized independently and separately from other components or steps described herein.

While the invention has been described in terms of various specific embodiments, those skilled in the art will recognize that the invention can be practiced with modification within the spirit and scope of the claims.

What is claimed is:

1. A method for producing a composition formulated for young livestock, the method comprises mixing distillers solubles with at least one of a milk replacer powder, whole milk, and waste milk.

2. A method in accordance with claim 1 wherein the composition includes at least about 16% total crude protein and at least about 10% total crude fat.

3. A method in accordance with claim 1 wherein the composition includes from approximately 16% to approximately 24% total crude protein, and from approximately 10% to approximately 20% total crude fat.

4. A method in accordance with claim 3 wherein the distillers solubles include from about 10% to about 20%, by weight on a dry matter basis, of the composition.

5. A method in accordance with claim 1, the method further comprising forming a solution by mixing the mixture of distillers solubles and a commercial milk replacer with a liquid.

6. A method in accordance with claim 5 wherein the solution is formulated for young calves.

7. A method in accordance with claim 5 wherein the solution is approximately 12.5% solids.

8. A method for feeding a young livestock animal, the method comprises feeding the young animal a composition including distillers solubles and at least one of a milk replacer powder, whole milk, and waste milk.

9. A method in accordance with claim 8 wherein feeding the young animal comprises feeding a young ruminant.

10. A method in accordance with claim 8 wherein feeding the young animal comprises feeding a calf.

11. A method in accordance with claim 8 wherein feeding the young animal comprises feeding the young animal the composition including at least about 16% total crude protein and at least about 10% total crude fat.

12. A method in accordance with claim 8 wherein feeding the young animal comprises feeding the young animal the composition including from about 22% to about 24% total crude protein, and at least about 10% total crude fat.

13. A method in accordance with claim 12 wherein feeding the young animal comprises feeding the young animal the composition that further includes Vitamin A, Vitamin D₃, and lysine.

14. A milk replacer composition for feeding a young livestock animal, the composition comprising distillers solubles and at least one of a milk replacer powder, whole milk, and waste milk.

15. A composition in accordance with claim 14 comprising distillers solubles from about 1% to about 95%, by weight on a dry matter basis, and further comprising additional supplements comprising at least one of vitamins, minerals, and amino acids from about 0.01% to about 10%, by weight on a dry matter basis.

16. A composition in accordance with claim 14 comprising distillers solubles from about 1% to about 75%, by weight on a dry matter basis, and further comprising additional supplements comprising at least one of vitamins, minerals, and amino acids from about 0.01% to about 10%, by weight on a dry matter basis.

17. A composition in accordance with claim 16 wherein the composition does not include whole milk or waste milk, and wherein a remaining balance of the composition comprises at least one ingredient selected from the group consisting of whey, whey protein concentrate, dried skim milk, soluble wheat gluten protein, wheat isolate, soy protein concentrate, soy isolate, soy flour, dried milk product, delactosed whey, and whey permeate.
